(19) United States
(12) Patent Application Publication
(10) Pub. No.: US 2026/0110227 A1
(43) Pub. Date: Apr. 23, 2026

(54) REAL-TIME WELL PRODUCTIVITY INDEX OPTIMIZATION IN UNDERBALANCED DRILLING

(71) Applicant: Schlumberger Technology Corporation, Sugar Land, TX (US)

(72) Inventors: Ali Hasan Alhashim, Dhahran (SA); Pedro Daniel Rangel Escarra, Dhahran (SA); Mazin Zain Elabdin Taha, Dubai (AE); Nour El Droubi, Abu Dhabi (AE); Samat Ramatullayev, Abu Dhabi (AE); Abdullah Yaseen Albuali, Abu Dhabi (AE); Hatem Darwish, Dhahran (SA); Wiliem Antonio Pavsin, Abu Dhabi (AE)

(21) Appl. No.: 18/919,540

(22) Filed: Oct. 18, 2024

(51) Int. Cl. E21B 21/08; E21B 7/04; G01V 99/00; G06T 11/20

(52) U.S. Cl. CPC E21B 21/085; E21B 7/04; G01V 99/00; G06T 11/26

(57) ABSTRACT

The present disclosure relates to systems and methods for real-time calculations of a productivity index and a rate-integral productivity index of a well in underbalance drilling. The systems and methods use real-time data received from the well to calculate the productivity index and the rate-integral productivity index of the well. The systems and methods use the productivity index and the rate-integral productivity index to generate visualizations of the well and provide recommendations for the well.

### BACKGROUND OF THE DISCLOSURE

Wellbores are commonly drilled from a surface location or seabed for various exploration and extraction activities. These wellbores are used to access and extract fluid resources like liquid and gaseous hydrocarbons from subterranean formations. The construction of wellbores involves the use of earth-boring equipment such as drill bits for initial drilling and reamers for enlarging the wellbore diameters.

The most common practice is to drill the wellbores using a drilling fluid that prevents the inflow of reservoirs fluids into the wellbore. This practice results in some of the drilling fluid invading the porous of the reservoir in the near wellbore area plugging this region and impairing later wellbore production, both short and long term. The plugging of the reservoir due to fluid invasion is referred to as “reservoir damage.”

Underbalanced drilling aims to minimize (even eliminate) reservoir damage by keeping wellbore pressure lower than formation pressure and thus preventing the drilling fluid from seeping into the reservoir.

As an additional consequence of drilling under balanced, reservoir fluids enter the wellbore and are produced during drilling operations. However, the surface production data and bottom hole assembly data are not integrated, leading to missed opportunities to better understand the quality of the wellbore being drilled, resulting in missed opportunities for optimal well placement and lower than desired recovery of resources from subterranean formations.

### SUMMARY

This summary is provided to introduce a selection of concepts that are further described in the detailed description. This summary is not intended to identify key or essential features of the claimed subject matter, nor is it intended to be used as an aid in limiting the scope of the claimed subject matter.

Some implementations relate to a method. The method includes receiving, in real-time, data from a well. The method includes calculating a productivity index in response to receiving the data from the well. The method includes calculating a rate-integral productivity index using the productivity index. The method includes generating, using the productivity index and the rate-integral productivity index, a visualization of a reservoir of the well. The method includes displaying, on a display, the visualization.

Some implementations relate to a system. The system includes a memory to store data and instructions; and a processor operable to communicate with the memory, wherein the processor is operable to: receive, in real-time, data from a well; calculate a productivity index in response to receiving the data from the well; calculate a rate-integral productivity index using the productivity index; generate, using the productivity index and the rate-integral productivity index, a visualization of a reservoir of the well; and display, on a display, the visualization.

Some implementations relate to a computer-readable storage medium including instructions that, when executed by a processor, cause the processor to: receive, in real-time, data from a well; calculate a productivity index in response to receiving the data from the well; calculate a rate-integral productivity index using the productivity index; generate, using the productivity index and the rate-integral productivity index, a visualization of a reservoir of the well; and display, on a display, the visualization.

Additional features and aspects of implementations of the disclosure will be set forth herein, and in part will be obvious from the description, or may be learned by the practice of such implementations. The features and advantages of such implementations may be realized and obtained by means of the instruments and combinations particularly pointed out in the appended claims. These and other features will become more fully apparent from the following description and appended claims, or may be learned by the practice of such implementations as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is an example of a downhole system in accordance with implementations of the present disclosure.

FIG. 2 illustrates an example of an intervention system in accordance with implementations of the present disclosure.

FIG. 3 illustrates an example environment for using a reservoir analysis tool for monitoring a well during drilling operations in accordance with implementations of the present disclosure.

FIG. 4 illustrates an example graphical user interface of a visualization in accordance with implementations of the present disclosure.

FIG. 5 illustrates an example method for monitoring a well productivity index during drilling operations in real-time in accordance with implementations of the present disclosure.

FIG. 6 illustrates components that may be included within a computer system.

### DETAILED DESCRIPTION

This disclosure generally relates to systems and methods for underbalanced drilling. Underbalanced drilling is a situation when the pressure (or force per unit area) exerted on a formation exposed in a wellbore is less than the internal fluid pressure of that formation. Under these conditions, if sufficient porosity and permeability exist, formation fluids enter the wellbore. The drilling rate typically increases as an underbalanced condition is approached.

Underbalanced drilling aims to improve drilling efficiency by keeping wellbore pressure lower than formation pressure. However, the surface production data and bottom hole assembly data are not integrated, leading to missed opportunities to better understand the quality of the wellbore being drilled, resulting in missed opportunities for optimal well placement and lower than desired recovery of resources from subterranean formations. Decisions on drilling are often made in existing solutions without real-time analysis of the productivity of the wellbore being drilled.

The systems and methods of the present disclosure enhance underbalanced drilling efficiency through real-time calculations of the well-productivity index (PI). The systems and methods include a reservoir analysis tool that leverages the data collected from a producing well and integrates surface gas rate data and downhole drilling parameters to calculate the well-productivity index in real-time on-the-fly. In some implementations, the reservoir analysis tool uses machine learning models to continuously assess the well-productivity index during drilling operations and provide recommendations in response to the well-productivity index. Example recommendations include zonal productivity, reservoir characteristics, well performance, and drilling adjustments. As will be discussed in further detail below, the present disclosure includes a number of practical applications having features described herein that provide benefits and/or solve problems associated with underbalanced drilling.

Some example benefits are discussed herein in connection with various features and functionalities provided by the reservoir analysis tool implemented on one or more computing devices. It will be appreciated that benefits explicitly discussed in connection with one or more implementations described herein are provided by way of example and are not intended to be an exhaustive list of all possible benefits of the reservoir analysis tool.

For example, one benefit includes enhanced efficiency. The reservoir analysis tool reduces non-productive time while drilling. Another example benefit includes increased recovery from reservoirs. The reservoir analysis tool aids in maximizing hydrocarbon extraction from reservoirs. Another example benefit includes providing data driven insights for the reservoirs. Users of the reservoir analysis tool gain immediate insights into well performance and can adjust drilling parameters in real-time to optimize productivity in response to the insights provided by reservoir analysis tool.

In some implementations, the systems and methods obtain surface measurements from a separator and downhole measurements from the bottom hole assembly at the well. The rate and pressure data are collected in real-time and used as an input to calculate the productivity index. The collected data is used to calculate the productivity index and the rate-integral productivity index of the well in real-time while drilling is occurring at the well. In some implementations, a machine learning model preforms the productivity index and the rate-integral productivity index calculations and provides recommendations based on the productivity index and the rate-integral productivity index.

The productivity index and the rate-integral productivity index help in understanding the production behavior of the well. The rate-integral productivity index is a performance metric that is used in reservoir engineering to assess the effectiveness of a well in a producing environment. In some implementations, the productivity index and the rate-integral productivity index are displayed as a curve in the log data. For example, calculations may be performed using the curve to identify productivity zones with a higher probability of producing more hydrocarbons.

One of the technical advantages of the systems and methods of the present disclosure is identifying the productivity index and the rate-integral index using the rate and pressure data received in real-time from the well. Another technical advantage of the systems and methods of the present disclosure is the time depth conversion of the collected data. The systems and methods generate visualizations of the reservoir using the data converted into a time domain. The visualizations provide different layering over time in real-time illustrating production zones where hydrocarbons production may be higher or areas in the reservoir that are likely not to produce or to produce hydrocarbons at a very low rate. Another technical advantage of the systems and methods of the present disclosure is increased recovery from reservoirs. The systems and methods use the productivity index and the rate-integral index to provide recommendations for drilling. Using the real-time calculations aids in boosting well performance and increasing production rates of a well. Another technical advantage of the systems and methods of the present disclosure is enhancement in drilling time and nonproductive time (NPT). The systems and methods help drill more enhanced wells with shorter time after identifying nonproductive zones in the wells.

The systems and methods enhance drilling improving the recovery of hydrocarbons. Improving well performance and improving the productivity index can lead to maximized hydrocarbon recovery while reducing operational costs. The productivity index provides insights into the characteristics of the reservoir that users can use to gain insights into well performance and can adjust well placement in real-time to optimize productivity of the reservoir by delivering optimal reservoir contact.

One example use of the systems and methods of the present disclosure is using the systems and methods with a coiled tubing drilling rig performing underbalanced drilling. Another example use of the systems and methods of the present disclosure is using the systems and methods with a rotary rig performing underbalanced drilling.

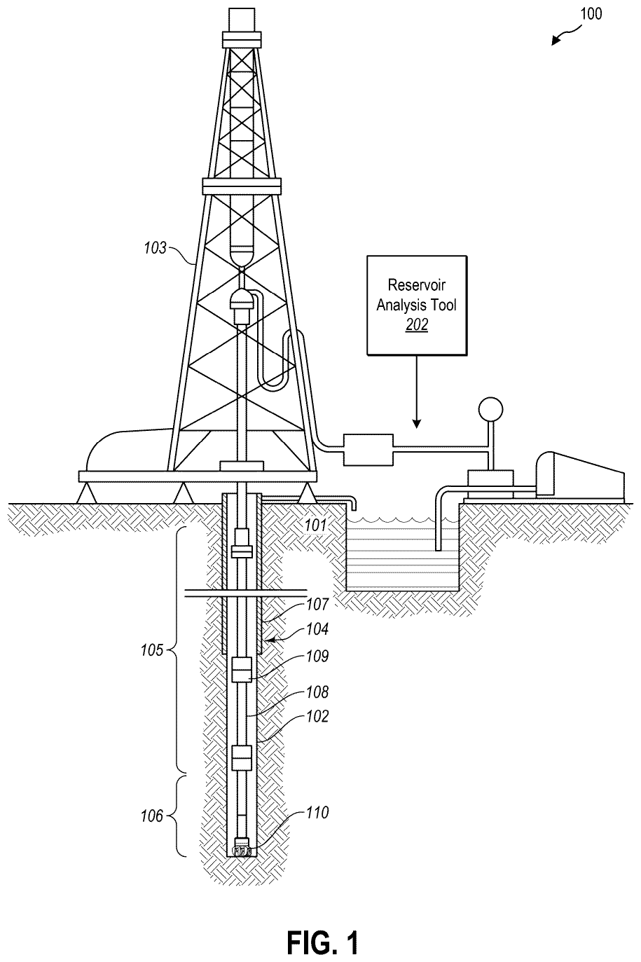

Additional details will now be provided regarding systems described herein in relation to illustrative figures portraying example implementations. For example, FIG. 1 shows one example of a downhole system 100 for drilling an earth formation 101 to form a wellbore 102. The downhole system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some implementations, the drill string 105 further includes additional downhole drilling tools and/or components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110, other downhole drilling tools, or other components. An example BHA 106 may include additional or other downhole drilling tools or components (e.g., coupled between the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing.

In general, the downhole system 100 may include other downhole drilling tools, components, and accessories such as special valves (e.g., kelly cocks, blowout preventers, and safety valves). Additional components included in the downhole system 100 may be considered a part of the drilling tool assembly 104, the drill string 105, or a part of the BHA 106, depending on their locations in the downhole system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other implementations, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to the surface 111 or may be allowed to fall downhole. The bit 110 may include one or more cutting elements for degrading the earth formation 101.

The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as one or more of gravity, magnetic north, or true north. Using measurements obtained with the geostationary position, the RSS may locate the bit 110, change the course of the bit 110, and direct the directional drilling tools on a projected trajectory. The RSS may steer the bit 110 in accordance with or based on a trajectory for the bit 110. For example, a trajectory may be determined for directing the bit 110 toward one or more subterranean targets such as an oil or gas reservoir.

The downhole system 100 may include or may be associated with a reservoir analysis tool 302. In some implementations, the reservoir analysis tool 302 is on a remote server in communication with the downhole system 100 via a network. The reservoir analysis tool 302 facilitates users with managing operations of the downhole system 100.

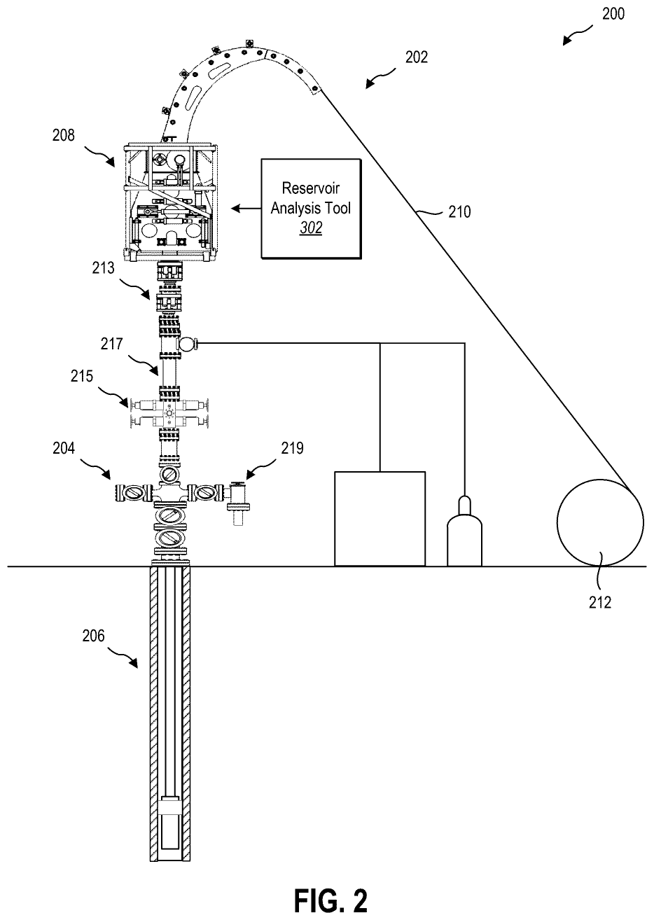

FIG. 2 illustrates one example of an intervention system 200. The intervention system 200 in the surface equipment zone may include a coiled tubing (CT) system 202 secured to a wellhead 204 connected to a well 206. The coiled tubing system 202 may perform an intervention in a well 206. To perform the intervention, an injection sub 208 may guide coiled tubing 210 from a coil 212 through the coiled tubing system 202. While the intervention system 200 illustrated includes a CT system, it should be understood that the intervention system 200 may include any type of intervention system, such as a wireline system, with their associated surface components.

The coiled tubing system 202 may include a stripper 213 below the injection sub 208 to contain and remove fluid from the intervention. Pressure control equipment 215 (PCE) is located below the stripper 213. A riser 217 may be located between the PCE 215 and the stripper 213 to raise the height of the connection between the injection sub 208 and the rest of the coiled tubing system 202. The PCE 215 may include one or more rams to shear the coiled tubing 210 in the coiled tubing system 202 and seal the coiled tubing system 202 from ingress of fluids from the well 206. The wellhead 204 may include a production valve 219. The production valve 219 may control and direct production fluid from the well 206 to storage, transportation, and/or processing.

The intervention system 200 may include or may be associated with a reservoir analysis tool 302. In some implementations, the reservoir analysis tool 302 is on a remote server in communication with the intervention system 200 via a network. The reservoir analysis tool 302 facilitates users with managing operations of the intervention system 200.

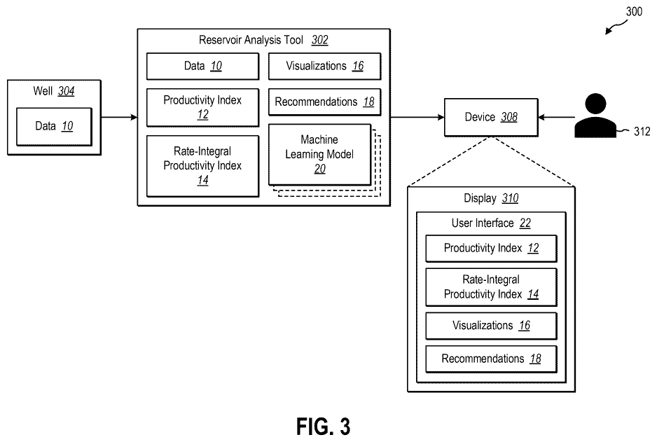

FIG. 3 illustrates an example environment 300 for using a reservoir analysis tool 302 for monitoring a well 304 during drilling operations. In some implementations, the well 304 is the downhole system 100 (FIG. 1). In some implementations, the well 304 is the intervention system 200 (FIG. 2). The reservoir analysis tool 302 receives the data 10 from the well 304. In some implementations, the reservoir analysis tool 302 is on a server in communication with the well 304 through a network. In some implementations, the reservoir analysis tool 302 is on a cloud server remote from the well 304 accessed through the network. The reservoir analysis tool 302 is hosted on virtual machines in the cloud. In some implementations, the reservoir analysis tool 302 is on an edge device at the well 304.

The network may include one or multiple networks and may use one or more communication platforms and/or technologies suitable for transmitting data. The network may refer to any data link that enables transport of electronic data between devices of the environment 300. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication. The server may include one or more computing devices (e.g., including processing units, data storage, etc.) organized in an architecture with various network interfaces for connecting to and providing data management and distribution across one or more client systems.

The reservoir analysis tool 302 receives the data 10 from the well 304 in real-time as drilling operations are occurring the well 304. In some implementations, the data 10 includes downhole data obtained from a bottom hole assembly in a time domain. Example downhole data includes bottom hole pressure (BHP), nitrogen rate (N2 rate), and total gas rate (Total Gas Rate). In some implementations, the data 10 includes reservoir pressure (SiBHP). In some implementations, the data 10 includes surface data obtained by a separator. The surface data is obtained in a time domain. Example surface data includes pressure, nitrogen rate, well head pressure, choke size, hydrocarbon production rates and circulation pressure.

The reservoir analysis tool 302 automatically preprocesses the data 10 to remove noise from the data 10 and correct any inconsistency in the data 10. For example, the reservoir analysis tool 302 standardizes the data 10 to ensure uniformity across different measurement sources and measurement units. The reservoir analysis tool 302 performs a unit conversion to ensure the data 10 is under one consistent measurement unit system.

In some implementations, the reservoir analysis tool 302 automatically performs a time domain to depth conversion of the data 10. The reservoir analysis tool 302 converts the time domain data (e.g., the surface data and the downhole data) to a depth domain. For example, the reservoir analysis tool 302 accounts for a time lag that occurs from obtaining the data 10 at a specific depth and moving through the wellbore and being recorded at the surface. The reservoir analysis tool 302 combines surface and downhole data into the depth domain to facilitate unified analysis of the data 10. As the data 10 is received from the well 304, the reservoir analysis tool 302 continuously preprocesses the data 10 and performs the time domain to depth conversion of the data 10.

The reservoir analysis tool 302 uses the data 10 to calculate a productivity index (PI) 12 of the well 304 and a rate-integral productivity index (RIPI) 14 of the well 304. The productivity index 12 is an indicator of the ability to produce hydrocarbons by the well 304. One example equation that the reservoir analysis tool 302 uses to calculate the productivity index 12 is illustrated below in equation (1):

$$PI = \frac{q}{Δ P} \qquad ( 1 )$$

where q is the flow rate and ΔP is the pressure drawdown.

In some implementations, ΔP is the underbalanced pressure calculated by subtracting the bottom hole pressure (BHP) from the reservoir pressure (SiBHP). The underbalanced pressure helps in understanding the pressure differential driving the gas flow from the reservoir into the wellbore. The rate and pressure are collected in real-time in the data 10 and is used as an input by the reservoir analysis tool 302 to calculate the productivity index 12 while drilling.

The rate-integral productivity index (RIPI) 14 is used in reservoir engineering to assess the effectiveness of a well in a producing environment. The rate-integral productivity index (RIPI) 14 helps in understating a production behavior of the well 304. A higher rate-integral productivity index 14 value generally indicates that the well produces at a more stable rate relative to the cumulative production, suggesting an effective drainage of the reservoir of the well 304.

One example equation that the reservoir analysis tool 302 uses to calculate the rate-integral productivity index 14 is illustrated below in equations (2) and (3):

$$RIPI = \frac{{q \vert}_{T}}{Δ P} \qquad ( 2 )$$

$$q = \frac{Q}{{t}_{c}} \qquad ( 3 )$$

where Q is the cumulative production (volume) for a given time interval, measured from t0 (input by the user, and to remain fixed) till the current time (t), and t_{c} is defined and is a running calculation in the form of t_{ci}=tᵢ−t₀ for any given time index (tᵢ). Q is the cumulative sum of the net gas rate over time. The time interval the is the difference between the current depth and the initial depth. The time-depth conversion aligns the surface and downhole data for unified analysis by the reservoir analysis tool 302. In some implementations, the reservoir analysis tool 302 calculates the rate-integral productivity index 14 per foot providing a normalized measure of productivity, helping to identify productive zones in the well 304. For example, productive zones are locations within a reservoir where hydrocarbons may be located. Another example of productive zones are locations where hydrocarbons production rates are achieved from the reservoir of the well 304.

In some implementations, the reservoir analysis tool 302 generates a curve of the productivity index 12 and the rate-integral productivity index 14 and presents the cure of the productivity index 12 and the rate-integral productivity index 14. In some implementations, the reservoir analysis tool 302 calculates derivatives of the productivity index 12 and the rate-integral productivity index 14 values to reduce noise and provide insights into the results.

The reservoir analysis tool uses the productivity index 12 and the rate-integral productivity index 14 to analyze the characteristics of the reservoir of the well 304 and the productivity of the well 304. For example, the reservoir analysis tool 302 uses the productivity index 12 and the rate-integral productivity index 14 values to identify the productivity zones of the reservoir of the well 304.

In some implementations, the reservoir analysis tool 302 uses the productivity index 12 and the rate-integral productivity index 14 to generate visualizations 16 of the reservoir of the well 304 in real-time as drilling operations are occurring. One example includes the visualization 16 illustrating layering of the reservoir over time in real-time.

Another example includes the visualizations 16 illustrating productivity zones in the reservoir of the well 304. For example, zones in the reservoir with a high productivity index 12 value (e.g., where the productivity index value is above an average productivity index value) may have a higher probability of containing hydrocarbons and zones in the reservoir with a low productivity index 12 value (e.g., where the productivity index value is below an average productivity index value) may have a lower probability of containing hydrocarbons. For example, the reservoir analysis tool 302 compares a value of the productivity index 12 for a zone of the reservoir to an average productivity index 12 of the well 304 to determine whether the zone is a high productivity area (e.g., exceeds the average) or the zone is a low productivity area (e.g., is below the average).

In some implementations, the reservoir analysis tool 302 generates one or more recommendations 18 based on the visualizations 16, the productivity index 12 and the rate-integral productivity index 14. One example recommendation 18 is to modify drilling operations. For example, the recommendation 18 suggests moving to a different location in the well 302, or changing a direction of drilling (e.g., up or down) in the well 304. Another example recommendation 18 is to suspend drilling operations in the well 304. Another example recommendation 18 is to maintain a current trajectory of drilling in the well 304.

In some implementations, the reservoir analysis tool 302 uses one or more machine learning models 20 to perform the calculations of the productivity index 12 and the rate-integral productivity index 14, generate the visualization 16, and provide the recommendations 18. The machine learning models 20 receive the data 10 in real-time as input and continuously calculate the productivity index 12 and the rate-integral productivity index 14 values for the data 10. The machine learning models 20 generate the visualizations 16 and provide the recommendations 18 in response to the stream of data 10 received from the well 304. The machine learning models 20 perform verifications to ensure the data 10 and the calculations performed are reliable and that errors did not occur in the calculations.

The reservoir analysis tool 302 outputs the productivity index 12 and the rate-integral productivity index 14 values, the visualizations 16, and the recommendations 18 as output. In some implementations, the reservoir analysis tool 302 provides the productivity index 12, the rate-integral productivity index 14, the visualizations 16, and the recommendations 18 to other applications or systems for further analysis or performing downstream tasks.

In some implementations, the reservoir analysis tool 302 displays any combination of values of the productivity index 12, values of the rate-integral productivity index 14, the visualizations 16, and the recommendations 18 on a user interface 22 of a display 310 so that a user 312 may see the information.

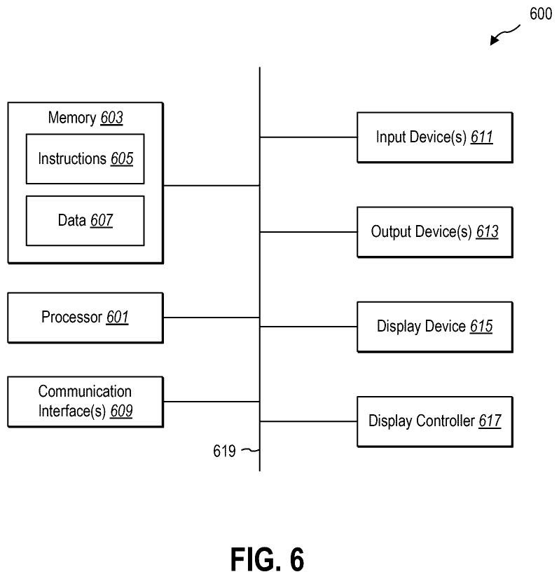

The user 312 accesses the reservoir analysis tool 302 using a device 308. The device 308 may be representative of one or multiple devices and may refer to various types of computing devices. For example, the device 308 may include a mobile device such as a mobile telephone, a smartphone, a personal digital assistant (PDA), a tablet, a laptop, or any other portable device. Additionally, or alternatively, the device 308 may include one or more non-mobile devices such as a desktop computer, server device, surface or downhole processor or computer (e.g., associated with a sensor, system, or function of the downhole system), or other non-portable device. In one or more implementations, the client device includes a graphical user interface (GUI) thereon (e.g., a screen of a mobile device). In addition, or as an alternative, one or more of the client devices may be communicatively coupled (e.g., wired or wirelessly) to a display having the GUI thereon for providing a display of system content. The server may similarly refer to various types of computing devices. Each of the devices of the environment 300 may include features and/or functionalities described below in connection with FIG. 6.

In some implementations, the reservoir analysis tool 302 is on a cloud server remote from the device 308 of the user 312 accessed through the network. The reservoir analysis tool 302 is hosted on virtual machines in the cloud. For example, a uniform resource locator (URL) configured to an end point of the reservoir analysis tool 302 is provided to the device 308 that the user 312 may access using a browser on the device 308. Another example includes an application on the device 308 of the user 312 provides access to the reservoir analysis tool 302.

The user 312 receives the visualizations 16 and recommendations 18 in real-time as drilling is occurring at the well 304. In some implementations, the user 312 uses the visualizations 16 and/or the recommendations 18 to modify the drilling operations of the well 304. For example, the user 312 decides to suspend drilling operations of the well 304 in response to the recommendations 18. Another example includes the user 312 changing a location of drilling in the well 304 in response to the visualization 16 indicating that the drilling is occurring in an area of the well 304 where hydrocarbons may not be located. Another example includes the user 312 changing a direction of drilling in response to the visualization 16 indicating that the drilling is occurring nearby an area where high hydrocarbons production rates may be achieved and the user 312 changes the direction of drilling towards the area where high hydrocarbons production rates may be achieved.

In some implementations, the user 312 uses the visualizations 16 to maintain a current trajectory of drilling at the well 304. For example, if the visualization 16 indicates that the drilling is occurring in an area of the well 304 where hydrocarbons may be present, the user 312 may decides to maintain the current trajectory of drilling at the well 304.

The real-time calculations of the productivity index 12 and the rate-integral productivity index 14, helps the users 312 in increasing well performance and increasing production rates of the well 304. The environment 300 enhances drilling, improving the overall recovery of hydrocarbons. Improved well performance and a better productivity index 12 can lead to maximized hydrocarbon recovery while also reducing operational costs of the well 304.

In some implementations, one or more computing devices (e.g., servers and/or devices) are used to perform the processing of the environment 300. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the reservoir analysis tool 302 is implemented on a single computing device. Moreover, in some implementations, one or more subcomponent of the feature and functionalities discussed herein may be implemented are processed on different server devices of the same or different cloud computing networks. For example, the reservoir analysis tool 302 is implemented on different server devices. In this way, the environment 300 may be a cloud computing environment, and the reservoir analysis tool 302 may be implemented across one or more devices of the cloud computing environment in order to leverage the processing capabilities, memory capabilities, connectivity, speed, etc., that such cloud computing environments offer in order to facilitate the features and functionalities described herein.

In some implementations, each of the components of the environment 300 is in communication with each other using any suitable communication technologies. In addition, while the components of the environment 300 are shown to be separate, any of the components or subcomponents may be combined into fewer components, such as into a single component, or divided into more components as may serve a particular implementation. In some implementations, the components of the environment 300 include hardware, software, or both. For example, the components of the environment 300 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 300 include hardware, such as a special purpose processing device to perform a certain function or group of functions. In some implementations, the components of the environment 300 include a combination of computer-executable instructions and hardware.

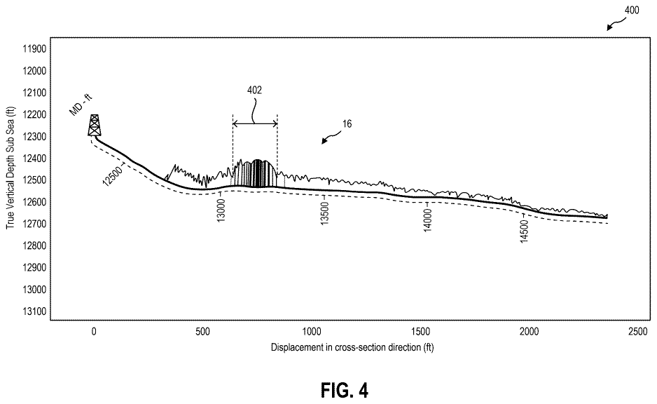

FIG. 4 illustrates an example graphical user interface 400 of a visualization 16. The visualization 16 illustrates a reservoir of the well 304 (FIG. 3) using the data 10 converted into a time domain. The visualization 16 identifies a productive zone 402 in the reservoir where hydrocarbons may be located. The visualization 16 also illustrates the trajectory of drilling in the well 304 along with a layering of the reservoir in real-time as drilling is occurring at the well 304. For example, the y-axis of the visualization 16 indicates a true vertical depth (TVD) which is the vertical distance from the surface or sea level to a point in the well, and the x-axis of the visualization 16 indicates the measured depth with the total length of the well with the deviations and horizontal section.

The reservoir analysis tool 302 (FIG. 3) automatically generates the visualization 16 in response to the data 10 (FIG. 3) received from the well 304. The reservoir analysis tool 302 updates the visualization 16 as new data 10 is received. The user 312 (FIG. 3) may use the visualization 16 in making drilling decisions for the well 304.

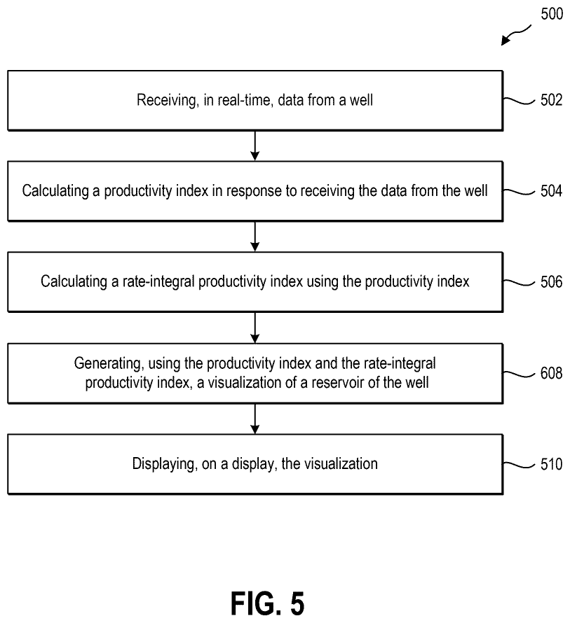

FIG. 5 illustrates an example method 500 for monitoring a well productivity index during drilling operations in real-time. The actions of the method 500 are discussed below in references to FIGS. 1-4.

At 502, the method 500 includes receiving, in real-time, data from a well. The reservoir analysis tool 302 receives the data 10 from the well 304 in real-time. In some implementations, the data includes surface measurements from a separator at the well 304 and downhole measurements from the bottom hole assembly at the well 304.

In some implementations, the reservoir analysis tool 302 automatically preprocesses the data 10 to remove noise from the data 10 and correct any inconsistency in the data 10. For example, the reservoir analysis tool 302 standardizes the data 10 to ensure uniformity across different measurement sources and measurement units. The reservoir analysis tool 302 performs a unit conversion to ensure the data 10 is under one consistent measurement unit system.

In some implementations, the reservoir analysis tool 302 performs a conversion of time domain data to depth domain data by combining the surface measurements and the downhole measurements and accounting for a time lapse from a current depth of the surface measurements and an initial depth for obtaining the downhole measurements.

At 504, the method 500 includes calculating a productivity index in response to receiving the data from the well. The productivity index identifies an ability of the well to produce hydrocarbons. The reservoir analysis tool 302 calculates the productivity index 12 in response to receiving the data 10 from the well 304. The data 10 is received in real-time from the well 304 and reservoir analysis tool 302 to calculate the productivity index 12 while drilling. For example, the reservoir analysis tool 302 uses equation (1) to calculate the productivity index 12. In some implementations, the reservoir analysis tool 302 calculates a productivity index per foot by dividing the productivity index by a delta of a distanced drilled (e.g., in feet) in the well 304. The productivity index per foot provides a measure of progress in the well per unit of energy or effort expended. Calculating the productivity index per foot while drilling an oil and gas well is beneficial for optimizing the drilling process and improving the overall efficiency of the well 304.

At 506, the method 500 includes calculating a rate-integral productivity index using the productivity index. The rate-integral productivity index identifies production stability of the well. The reservoir analysis tool 302 calculates the rate-integral productivity index 14 using the productivity index 12. For example, the reservoir analysis tool 302 uses equations (2) and (3) to calculate the rate-integral productivity index 14. A higher rate-integral productivity index 14 value generally indicates that the well produces at a more stable rate relative to the cumulative production, suggesting an effective drainage of the reservoir of the well 304.

At 508, the method 500 includes generating, using the productivity index and the rate-integral productivity index, a visualization of a reservoir of the well. In some implementations, the reservoir analysis tool 302 uses the productivity index 12 and the rate-integral productivity index 14 to generate a visualization 16 of a reservoir of the well 304 as drilling operations are occurring. In some implementations, the visualization 16 displays a real-time layering of the reservoir of the well 304. In some implementations, the visualization 16 identifies productive zones where hydrocarbons production rates are achieved from the reservoir of the well 304.

In some implementations, the reservoir analysis tool 302 generates one or more recommendations 18 based on any combination of the productivity index 12, the rate-integral productivity index 14, and the visualization 16. For example, the reservoir analysis tool 302 automatically outputs a recommendation 18 to modify a trajectory of drilling in the well 304 to a location different from a current trajectory of drilling in response to the visualization 16 identifying a productive zone at the location (e.g., an area of the reservoir with a probability of containing hydrocarbons).

Another example includes the reservoir analysis tool 302 automatically outputting a recommendation 18 to suspend drilling in the well 304 in response to a value for the productivity index 12 being below a threshold. One example threshold is an average value of productivity index values.

In some implementations, the machine learning model 20 calculates the productivity index 12, the rate-integral productivity index 14, generates the visualizations 16, and provides the recommendations 18. The machine learning model 20 continually updates the visualization 16 in response to updated productivity index and updated rate-integral productivity index calculations as new data is received from the well 304.

At 510, the method 500 includes displaying, on a display, the visualization. For example, the reservoir analysis tool 302 displays the visualization 16 on a user interface 22 of a display 310. In some implementations, the reservoir analysis tool 302 displays the values of the productivity index 12 and the rate-integral productivity index 14 on the user interface 22 of the display 310. In some implementations, the user 312 uses the visualizations 16 and/or the recommendations 18 to modify the drilling operations of the well 304.

The method 500 uses the productivity index 12 and the rate-integral productivity index 14 to analyze the characteristics of the reservoir of the well 304 and the productivity of the well 304. The real-time calculations of the productivity index 12 and the rate-integral productivity index 14, helps the users 312 in increasing well performance and increasing production rates of the well 304, improving the overall recovery of hydrocarbons.

Turning now to FIG. 6, this figure illustrates certain components that may be included within a computer system 600. One or more computer systems 600 may be used to implement the various devices, components, and systems described herein.

The computer system 600 includes a processor 601. The processor 601 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, implementation of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of implementations of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 609 may connect the computer system 600 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with implementations disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into one or more of text, graphics, or moving images (as appropriate) shown on the display device 615.

The various components of the computer system 600 may be coupled together by one or more buses, which may include one or more of a power bus, a control signal bus, a status signal bus, a data bus, other similar components, or combinations thereof. For the sake of clarity, the various buses are illustrated in FIG. 6 as a bus system 619.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Further, upon reaching various computer system components, program code in the form of computer-executable instructions or data structures can be transferred automatically or manually from transmission media to non-transitory computer-readable storage media (or vice versa). For example, computer executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from ¶¶[0015]-[0084] includes various implementations that, where feasible, may be combined in any permutation. For example, the implementation of ¶¶[0015]-[0084] may be combined with any or all implementations of the following paragraphs. Implementations that describe acts of a method may be combined with implementations that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some implementations, a method includes receiving, in real-time, data from a well. The method includes calculating a productivity index in response to receiving the data from the well. The method includes calculating a rate-integral productivity index using the productivity index. The method includes generating, using the productivity index and the rate-integral productivity index, a visualization of a reservoir of the well. The method includes displaying, on a display, the visualization.

In some implementations, the method includes calculating a productivity index per foot by dividing the productivity index by a delta of a distanced drilled in the well.

In some implementations, the method includes the productivity index per foot provides a measure of progress in the well per unit of energy.

In some implementations, the method includes the visualization identifies productive zones where hydrocarbons production rates are achieved from the reservoir of the well.

In some implementations, the method includes automatically outputting a recommendation to modify a trajectory of drilling in the well to a location different from a current trajectory of drilling in response to the visualization identifying a productive zone at the location.

In some implementations, the method includes automatically outputting a recommendation to suspend drilling in the well in response to a value for the productivity index being below a threshold.

In some implementations, the method includes the data from surface measurements obtained from a separator at the well and downhole measurements obtained from the bottom hole assembly at the well.

In some implementations, the method includes performing a conversion of time domain data to depth domain data by combining the surface measurements and the downhole measurements and accounting for a time lapse from a current depth of the surface measurements and an initial depth for obtaining the downhole measurements.

In some implementations, the method includes a machine learning model calculates the productivity index and the rate-integral productivity index and generates the visualization.

In some implementations, the method includes the machine learning model continually updating the visualization in response to updated productivity index and updated rate-integral productivity index calculations as new data is received from the well.

In some implementations, the method includes the visualization displays a real-time layering of the reservoir of the well.

In some implementations, the method includes the productivity index identifies an ability of the well to produce hydrocarbons and the rate-integral productivity index identifies production stability of the well.

In some implementations, the system includes a memory to store data and instructions; and a processor operable to communicate with the memory, wherein the processor is operable to: receive, in real-time, data from a well; calculate a productivity index in response to receiving the data from the well; calculate a rate-integral productivity index using the productivity index; generate, using the productivity index and the rate-integral productivity index, a visualization of a reservoir of the well; and display, on a display, the visualization.

In some implementations, a computer-readable storage medium including instructions that, when executed by a processor, cause the processor to: receive, in real-time, data from a well; calculate a productivity index in response to receiving the data from the well; calculate a rate-integral productivity index using the productivity index; generate, using the productivity index and the rate-integral productivity index, a visualization of a reservoir of the well; and display, on a display, the visualization.

The implementations of the wellbore extraction tool have been primarily described with reference to wellbore drilling operations; the wellbore extraction tool described herein may be used in applications other than the drilling of a wellbore. In other implementations, the wellbore extraction tool according to the present disclosure may be used outside a wellbore or other downhole environment used for the exploration or production of natural resources. For instance, the wellbore extraction tool of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific implementations of the present disclosure are described herein. These described implementations are examples of the presently disclosed techniques. Additionally, in an effort to provide a concise description of these implementations, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. There is no intention to invoke means-plus-function or other functional claiming for any claim except for those in which the words ‘means for’ appear together with an associated function. Each addition, deletion, and modification to the implementations that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving, in real-time, data from a well;
calculating a productivity index in response to receiving the data from the well;
calculating a rate-integral productivity index using the productivity index;
generating, using the productivity index and the rate-integral productivity index, a visualization of a reservoir of the well; and
displaying, on a display, the visualization.

2. The method of claim 1, wherein calculating the productivity index further comprises calculating a productivity index per foot by dividing the productivity index by a delta of a distanced drilled in the well.

3. The method of claim 2, wherein the productivity index per foot provides a measure of progress in the well per unit of energy.

4. The method of claim 1, wherein the visualization identifies productive zones where hydrocarbons production rates are achieved from the reservoir of the well.

5. The method of claim 4, further comprising:
automatically outputting a recommendation to modify a trajectory of drilling in the well to a location different from a current trajectory of drilling in response to the visualization identifying a productive zone at the location.

6. The method of claim 1, further comprising:
automatically outputting a recommendation to suspend drilling in the well in response to a value for the productivity index being below a threshold.

7. The method of claim 1, wherein the data includes surface measurements from a separator at the well and downhole measurements from a bottom hole assembly at the well.

8. The method of claim 7, further comprising:
performing a conversion of time domain data to depth domain data by combining the surface measurements and the downhole measurements and accounting for a time lapse from a current depth of the surface measurements and an initial depth for obtaining the downhole measurements.

9. The method of claim 1, wherein a machine learning model calculates the productivity index and the rate-integral productivity index and generates the visualization.

10. The method of claim 9, wherein the machine learning model continually updates the visualization in response to updated productivity index and updated rate-integral productivity index calculations as new data is received from the well.

11. The method of claim 1, wherein the visualization displays a real-time layering of the reservoir of the well.

12. The method of claim 1, wherein the productivity index identifies an ability of the well to produce hydrocarbons and the rate-integral productivity index identifies production stability of the well.

13. A system, comprising:
a memory to store data and instructions; and
a processor operable to communicate with the memory, wherein the processor is operable to:
receive, in real-time, data from a well;
calculate a productivity index in response to receiving the data from the well;
calculate a rate-integral productivity index using the productivity index;
generate, using the productivity index and the rate-integral productivity index, a visualization of a reservoir of the well; and
display, on a display, the visualization.

14. The system of claim 13, wherein the processor is further operable to calculate the productivity index by calculating a productivity index per foot by dividing the productivity index by a delta of a distanced drilled in the well, wherein the productivity index per foot provides a measure of progress in the well per unit of energy.

15. The system of claim 13, wherein the visualization identifies productive zones where hydrocarbons production rates are achieved from the reservoir of the well and the processor is further operable to automatically output a recommendation to modify a trajectory of drilling in the well to a location different from a current trajectory of drilling in response to the visualization identifying a productive zone at the location.

16. The system of claim 13, wherein the processor is further operable to:
automatically output a recommendation to suspend drilling in the well in response to a value for the productivity index being below a threshold.

17. The system of claim 13, wherein the data includes surface measurements from a separator at the well and downhole measurements from a bottom hole assembly at the well.

18. The system of claim 17, wherein the processor is further operable to:
perform a conversion of time domain data to depth domain data by combining the surface measurements and the downhole measurements and accounting for a time lapse from a current depth of the surface measurements and an initial depth for obtaining the downhole measurements.

19. The system of claim 13, wherein the processor is further operable to use a machine learning model to calculate the productivity index and the rate-integral productivity index and generates the visualization and the machine learning model continually updates the visualization in response to updated productivity index and updated rate-integral productivity index calculations as new data is received from the well.

20. The system of claim 13, wherein the productivity index identifies an ability of the well to produce hydrocarbons and the rate-integral productivity index identifies production stability of the well.
